(19) United States
(12) Patent Application Publication
(10) Pub. No.: US 2020/0019824 A1
(43) Pub. Date: Jan. 16, 2020

(54) System and Method of Grading AI Assets

(71) Applicant: CrowdCare Corporation, Richmond Hill, CA (US)

(72) Inventors: Ian Collins, Markham (CA); Jeffrey Brunet, Aurora (CA); Karthik Balakrishnan, Etobicoke (CA); Yousuf Chowdhary, King City (CA); Karen Chan, Richmond Hill (CA)

(21) Appl. No.: 16/507,230

(22) Filed: Jul. 10, 2019

Related U.S. Application Data
(60) Provisional application No. 62/696,657, filed on Jul. 11, 2018.

(51) Int. Cl. G06K 9/62; G06N 20/00; G06N 3/08

(52) U.S. Cl. CPC G06K 9/6262; G06N 3/08; G06N 20/00

(57) ABSTRACT

A method is provided for grading an artificial intelligence (AI) asset. After an AI asset is received for transaction, its performance is evaluated on a specialized task and a baseline of performance is established based on an evaluated state of the AI asset. The AI asset is then graded based on the evaluated performance in a task-environment. A value is ascribed to the AI asset. The AI asset is made available for transaction on an AI asset exchange. A related method is also provided where a second evaluation and grading are performed after the AI asset is trained.

### CROSS-REFERENCE TO RELATED APPLICATIONS

This application claims the benefit of U.S. Patent App. Ser. No. 62/696,657, filed Jul. 11, 2018, the contents of which are hereby incorporated by reference in its entirety.

### FIELD OF INVENTION

The invention in general relates to artificial intelligence (AI) and in particular relates to providing a system and method for grading AI assets.

### BACKGROUND OF THE INVENTION

Artificial Intelligence (AI) aims to be able to provide capabilities such that computing platforms can perform intelligent human processes such as reasoning, learning, problem solving, perception, language understanding etc. AI also aims to use computing to solve problems related to prediction, classification, regression, clustering, function optimization among a host of others.

It would be advantageous to have a mechanism to evaluate and grade different AI assets to facilitate trade, so that entities could benefit from the AI resources developed by others to speed up the evolution of their own AI assets.

Existing methods do not provide mechanisms or platforms that enable the exchange of different artificial intelligence (AI) assets developed by different entities; whether for monetary gain or for open source resource development or for collaborative work.

Prior art methods also do not provide mechanisms for grading AI assets by third parties that are neutral to the transaction. Prior art methods lack mechanisms to evaluate and grade AI assets to highlight their relevance, applicability and usefulness to certain business problems or market niches while also pointing out their ineffectiveness in other areas. Thus, having such methods and systems facilitates in knowing where an AI asset would produce best results while also knowing in what other scenario they may not produce meaningful results.

### SUMMARY

Broadly speaking, the present invention provides a method and a system of grading artificial intelligence (AI) assets and using this system preferably in an AI Asset Exchange where different entities can buy, sell, barter, trade, rent, borrow, exchange, collaborate etc. different AI assets. The parties may have developed the AI assets themselves, or may possess rights to use those AI assets.

It would be advantageous to have a mechanism to grade different AI assets whereby entities could benefit from the AI resources developed others to speed up their own evolution, and then the AI resources at different stages of training and other improvement may be offered through the AI Asset Exchange. At least one such AI Asset Exchange method and system is described and taught in applicants' previous U.S. patent application Ser. No. 16/404,849, filed on May 7, 2019, the contents of which are incorporated by reference.

The present systems and methods aid in providing a better insight as to where an AI asset would produce best results while also knowing in what other scenario they may not produce meaningful results.

The AI Asset Exchange may be responsible for grading AI assets, management, transaction management, rights and encryption key(s) management, data management, model management, amongst other related functions.

In one embodiment Entity A registers with the AI Asset Exchange such that the registration process may require that information about the entity and its representatives may be added to the system.

In one embodiment Entity A defines its AI asset(s). For example, if the AI asset is a data set, then the definition may include what kind of data it is, the size of the data set, its bias. If the AI asset is an AI model, then the definition may include what kind of AI model it is, the model's applicability, the industry or vertical that it may be trained on, etc. In one embodiment Entity A uploads its AI asset(s) to the AI Asset Exchange.

In one embodiment the AI asset is evaluated. Evaluation is the empirical means through which an observing system, an evaluator, obtains information about another system under test, by systematically observing its behavior. Evaluation in the field of artificial intelligence (AI) implies measuring a system's performance on a specialized task and may be particularly appropriate for systems targeted at narrow tasks and domains.

Through the AI asset evaluation, a baseline is created that may preferably be used for comparisons and other associated functions.

After evaluation, the AI asset is graded. For example, the grading of the AI assets may use a numerical, alphabetical or qualitative grading scale—a percentage, grading as out of five stars, grading from A+ to F where A+ is exceptional and F is a fail, grading in 10 to zero numerical for example where 10 is exceptional and 0 is fail, grading with definition e.g. exceptional, excellent, very good, good, fair, passable and fail etc.

Grading may also include providing details about the AI asset's relevance and applicability to a given industry or particular industries or niches within industries. As an example, when an AI model or a dataset is evaluated against many different scenarios, it may be noted that its performance was better in a given scenario but it performed poorly in another. Thus, the evaluation process against a wide range of methods and models may be advantageously used to grade the AI asset vis-à-vis given industries, niches, business scenarios, problems etc.

Grading may also include defining the relevance of the AI asset and ranking it for a given industry or a niche in a given industry or multiple industries. The ranking may preferably list in a descending order, the performance and evaluation results for multiple industries and niches in given industries thus aiding in defining its higher relevance to some industries as opposed to some others where it may have performed poorly.

For example, a given AI asset (e.g. a dataset) may be better suited for training AI models in the medical field but may perform poorly when models in the telecom industry are trained. Thus, evaluation of such a dataset with multiple models designed for different industries and scenarios may be used to ascertain the said dataset's relevance to the medical field with a high ranking while also defining that its relevance and ranking as low for the telecom industry. Therefore, such definition of relevance, applicability and ranking will aid in the grading of the AI asset.

An AI asset can be data or a model; and any AI asset can be bought, sold, rented, leased; fully (whole) or partially (a subset of the data, say 50%) bartered, exchanged, borrowed, collaborated on etc. An AI asset is tangible (e.g. data or model) can be transacted, can be assigned value, can be graded by the system and rated by the user, can be extended or muted. The AI Asset Exchange can be responsible for asset management, transaction management, rights (encryption key) management, data management, model management, grading of assets.

While the application cites several examples for specific AI assets, in fact the intent is to cover all such AI software, modules, models, algorithms etc. that may exist currently or will be developed or may evolve over time as a result of advancements in related technological fields.

According to a first aspect of the invention, a method is provided for grading an artificial intelligence (AI) asset. After an AI asset is received for transaction, its performance is evaluated on a specialized task and a baseline of performance is established based on an evaluated state of the AI asset. The AI asset is then graded based on the evaluated performance in a task-environment. A value is ascribed to the AI asset. The AI asset is made available for transaction on an AI asset exchange.

For example, the AI asset may be an AI model, in which case the evaluation step may include evaluation on a set of test data for which true values are known, e.g. an MNIST data set.

The baseline may be a baseline measurement of accuracy, precision, recall, or a weighted average of precision and recall (to take a few examples). The evaluation may be an intrinsic evaluation or an extrinsic evaluation. The evaluation may be a formative evaluation or a summative evaluation.

For example, the AI asset may be a classification model, in which case the evaluation step may include evaluation in a confusion matrix.

The evaluation may be for reliability in a core area of expertise, for predictability, learning/adaptation ability, adaptivity, the ability to recursively self-improve, or for resource or time requirements (to take a few examples).

Where the AI asset is a chatbot or dialogue model, the evaluation may incorporate a recurrent neural network (RN N) architecture.

According to a second aspect of the invention, a method is provided for grading an artificial intelligence (AI) asset. An AI asset is received for transaction. A first evaluation is performed of the performance of the AI asset on a specialized task and a baseline of performance is established based on an evaluated state of the AI asset. A first grading is performed of the AI asset based on the evaluated performance in a task-environment. A first valuation is ascribed to the AI asset. Following a transaction to a party of the AI asset for training the AI asset, the AI asset is received back from the party. A second evaluation is performed of the performance of the AI asset on the same specialized task and the performance is compared to the baseline. A second grading of the AI asset is performed based on the comparison to the baseline. A second valuation is ascribed to the AI asset. The AI asset may then be made available at the second value.

### BRIEF DESCRIPTION OF THE FIGURES

FIG. 1 is a flow diagram illustrating a basic process for grading AI assets for use with an AI asset exchange.

FIG. 2 is a logical diagram illustrating possible configurations of parties (entities) and assets mediated through a related AI asset exchange.

FIG. 3 is a flow diagram illustrating a process for grading a retrained AI asset.

FIG. 4 is a flow diagram illustrating a process for grading an AI data asset that has been updated.

FIG. 5 is an exemplary confusion matrix.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example, and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a standalone computer, a server, a server farm, virtual machines, on the mobile device as a stand-alone software package; partly on the mobile device and partly on a remote computer or remote computing device or entirely on the remote computer or server or computing device. In the latter scenario, the remote computers may be connected to each other or the mobile devices through any type of network, including a local area network (LAN) or a wide area network (WAN), or the connection may be made to the internet through a mobile operator network (e.g. a cellular network); WiFi, Bluetooth etc.

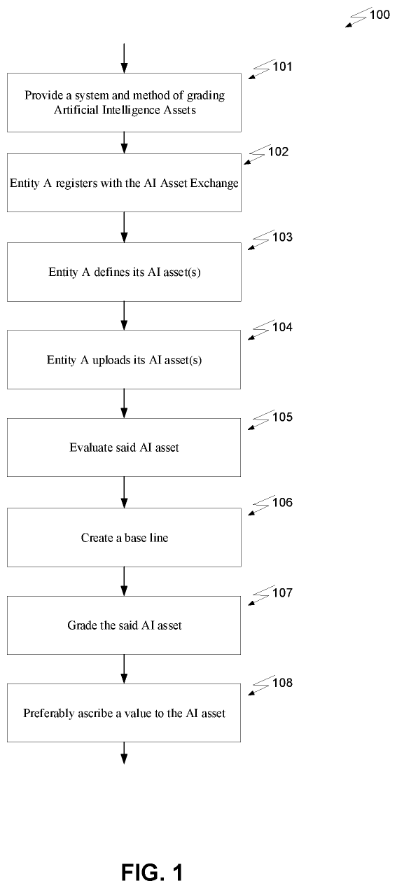

FIG. 1 shows one embodiment in which a system and method is provided of grading Artificial Intelligence Assets 101. A system and method of grading Artificial Intelligence Assets is preferably used in an AI Asset Exchange where different entities can buy, sell, barter, trade, rent, borrow, exchange, collaborate etc. different AI assets that they may have developed or possess rights to. The AI Asset Exchange may be responsible for grading AI assets, management, transaction management, rights and encryption key(s) management, data management, model management, among other related functions.

Artificial Intelligence (AI) aims to be able to provide capabilities such that computing platforms can perform intelligent human processes like reasoning, learning, problem solving, perception, language understanding etc. AI also aims to use computing to solve problems related to prediction, classification, regression, clustering, function optimization among a host of others.

It would be advantageous to have a mechanism to grade AI assets to facilitate trade and transaction of different AI assets whereby entities could benefit from the AI resources developed by others to speed up their own evolution. The system and method of the invention aims to providing a platform that acts like a stock exchange where AI assets can be transacted by different parties.

The functionality of the AI Asset Exchange may be embedded in another platform or may be associated with a stock exchange where stock and commodities are traded using market-based pricing mechanisms.

While the application cites several examples for AI assets, in fact the intent is to cover all such AI software, modules, models, algorithms etc. that may exist currently or will be developed or may evolve over time as a result of the advancements in the related technological fields.

Entity A registers with the AI Asset Exchange 102. The registration process may require that information about the entity and its representatives may be added to the system.

An AI asset can be data or a model; and any AI asset can be bought, sold, rented, leased, traded, borrowed, lent, donated, exchanged; fully (whole) or partially (a subset e.g. 50%).

An AI asset is tangible (e.g. data, algorithm, model) and can be transacted, can be assigned value, can be graded by the system and rated by the system and/or users, and can be extended or muted.

The AI Asset Exchange may be responsible for asset management, trade and financial transaction management, rights and encryption key(s) management, data management, model management, grading of assets among a host of other functions.

Entity A defines its AI asset(s) 103. For example, if the AI asset is a data set, then the definition may include what kind of data it is, its size, and its bias. If the AI asset is an AI model, then the definition may include what kind of an AI model it is, the model's applicability, the industry or vertical that it may be trained on, etc.

Entity A uploads the AI asset(s) 104 to the AI Asset Exchange.

The AI asset is evaluated 105. Evaluation is the empirical means through which an observing system, an evaluator, obtains information about another system under test, by systematically observing its behavior. Evaluation in the field of artificial intelligence (AI) implies measuring a system's performance on a specialized task and may be particularly appropriate for systems targeted at narrow tasks and domains.

Artificial Intelligence (AI) aims to provide systems that can perform tasks that currently require human intelligence. Generally, an AI system is designed for a particular role requiring it to perform a task or a range of tasks. Tasks enable an AI system to trained and evaluated.

The ultimate goal of evaluation is to obtain information about an Artificial Intelligent system and its properties. This can be achieved, for example, by observing its performance (behavior) as it interacts with a task-environment and/or the state that the task-environment is left in.

Black-box evaluation methods look only at the input-output behavior of the system under test and its consequences, while clear-box testing can also look at a system's internals. For fair and objective comparisons between different systems (e.g. humans and machines), black-box testing is typically desirable. Nevertheless, looking at gathered and utilized knowledge, or considering the performance of different modules separately can be quite informative—e.g. when debugging, finding weak points, or assessing understanding.

AI systems interact with task-environments, which are tuples of a task and an environment. An environment contains objects that a system-under-test can interact with—which may form larger complex systems such as other intelligent agents—and rules that describe their behavior, interaction and affordances. A state is a configuration of these objects at some point or range in time. Tasks specify criteria for judging the desirability of states and whether or not they signify the successful or unsuccessful end of a task.

Tasks are used for training and evaluating AI systems, which are built in order to perform and automatize tasks currently performed by people. Tasks can be divided in various ways into different sets of subtasks, and AI systems may choose which tasks or subtasks to pursue and which ones to ignore.

In one embodiment a task theory and a test theory may be utilized for specifying how to construct a variety of evaluation tests and methods as required depending on the nature of the AI model that is being evaluated.

In one embodiment a task theory may be utilized to enable addressing tasks at the class level, bypassing their specifics, providing the appropriate formalization and classification of tasks, environments, and their parameters, resulting in more rigorous ways of measuring, comparing, and evaluating AI models and their behavior against different data sets.

The manner in which the task is communicated to the system-under-test is left open and depends on the system and desired results of the evaluation. For instance, in AI planning the task is usually communicated to the system as a goal state at the start, while most reinforcement learners only get sporadic hints about what the task is through valuations of the current state.

Specialized AI models (i.e. those designed to undertake specified tasks) may be evaluated differently from AI models designed for general purpose (artificial general intelligence).

A specialized AI model or system may be particularly evaluated for reliability in the specified range of tasks and situations pertinent to its core area of expertise.

An AI model may be evaluated for task-specific performance and for a range of situations in which AI model will behave according to specification.

In one embodiment the AI model may be evaluated for predictability. Predictability results not just from vigorous quantitative tests, but also from more qualitative tests of a system's understanding.

In one embodiment the AI model may be evaluated for robustness, learning/adaptation ability and understanding of fundamental values, as well as performance under various conditions.

In one embodiment the AI model may be evaluated for adaptivity. To measure the adaptivity of a system, it is not only important to look at the rate at which a new task is learned, but also how much new knowledge or new data sets are required.

In one embodiment the AI model may be evaluated based on learn rate property to predict with some accuracy what would be needed to learn the new task depending on known details such as task size and complexity.

In one embodiment the AI model may be evaluated for robustness. When evaluating for robustness, the two main things to consider are if and when the system breaks down and how it behaves and how well the system degrades and does it degrade gracefully.

In one embodiment the AI model may be evaluated for the model's ability to recursively self-improve given one or more break downs.

In one embodiment an analysis and calculation of the time required, energy consumed or other resource requirements (e.g. number of CPUs and their usage load and yields of task completion) may also be used in the evaluation of the AI system.

In one embodiment Recurrent Neural Networks (RNNs), typically in the form of an encoder-decoder architecture, may be utilized for evaluating chatbots and dialogue models. In one such embodiment one network ingests an incoming message, for example a customer utterance, a Tweet, a chat message, and the like, and a second network generates an outgoing response, conditional on the first network's final hidden state.

In another embodiment an adversarial evaluation method may be used for evaluating for dialogue models.

General purpose AI models, which are purpose designed to be able to accomplish a wide range of tasks, including those not foreseen by the system's designers, are preferably evaluated with different methods (and principles) from those used for evaluating specialized systems or models targeted at narrow tasks and domains. For example, general-purpose systems may be particularly required to be adaptive in order to deal with unforeseen situations not envisioned by the system's designers, and thus have a greater need to learn and change over time.

Evaluating general-purpose Artificial Intelligence (AI) systems is a challenge due to the combinatorial state explosion inherent in any system-environment interaction where both system and environment are complex. Furthermore, systems exhibiting some form of general intelligence must necessarily be highly adaptive and continuously learn, adapt and change in order to deal with new situations that may not have been foreseen during the system's design or implementation.

Artificial Intelligent systems interact with task-environments, which are tuples of a task and an environment. An environment contains objects that a system-under-test can interact with—which may form larger complex systems such as other intelligent agents—and rules that describes their behavior, interaction and affordances. A state is a configuration of these objects at some point or range in time. Tasks specify criteria for judging the desirability of states and whether or not they signify the successful or unsuccessful end of a task.

A baseline is created 106 that may preferably be used for comparisons and other associated functions.

The AI asset is graded 107. Preferably the grading of the AI assets may be along the lines of one of the many different methods or scales of grading e.g. grading as a percentage, grading as out of five star, grading from A+ to F where A+ is exceptional and F is a fail, grading in 10 to zero numerical for example where 10 is exceptional and 0 is fail, grading with definition e.g. exceptional, excellent, very good, good, fair, passable and fail etc.

In another embodiment a combination of numerical and definition-based grading may be used e.g. A+: 90-100; A: 85-89; A−: 80-84; B+: 75-79; B: 70-74; C+: 65-69; C: 60-64; D+: 55-59; D: 50-54; E: 40-49; F: 0-39.

Preferably grading of an AI asset also provides more information and a better understanding about its relevance and applicability to a given business, a given business scenario, a given industry or a given niche within an industry or to the problems that it aids to solve.

The systems and methods presently disclosed aid in providing a better insight as to where an AI asset would produce best results while also knowing in what other scenario they may not produce meaningful results.

Grading may preferably also include added aspects like providing details about the AI asset's relevance and applicability to a given industry or particular industries or niches within industries. As an example, when an AI model or a dataset is evaluated against many different scenarios, it may be noted that its performance was better in a given scenario but it performed poorly in another. Thus, the evaluation process against a wide range of methods and models may be advantageously used to grade the AI asset vis-à-vis given industries, niches, business scenarios, problems etc.

Grading may preferably also include defining relevance and ranking for a given industry, a niche in a given industry or multiple industries. The ranking may preferably list in a descending order, the performance and evaluation results for multiple industries and niches in given industries thus aiding in defining its higher relevance to some industries as opposed to some others where it may have performed poorly.

For example, a given AI asset e.g. a dataset may be better suited for training AI models in the medical field but may perform poorly when models in the telecom industry are trained. Thus, evaluation of such a dataset with multiple models designed for different industries and scenarios may be used to ascertain the said dataset's relevance to the medical field with a high ranking while also defining that its relevance and ranking as low for the telecom industry. Therefore, such definition of relevance, applicability and ranking will aid in the grading of the AI asset.

Preferably a value is ascribed to the AI asset 108 based on the grade that it scored. The ascribed value may be used as a baseline for comparisons and may be a relative value which may change as the entire AI Asset Exchange expands and contracts and also based on market forces of supply and demand.

Preferably the information about an AI asset's applicability and its relevance to given businesses or business scenarios may also be used when ascribing a value. In one embodiment the listing and ranking of the different industries or industry niches may also impact the value that is ascribed to it.

Preferably when ascribing value, an AI asset's relevance and ranking for different industries and niches within industries may also be taken into account. Preferably a higher value may be ascribed if an AI asset performs consistently for more than one industry or niche. The industry or the niche within an industry may also play a part in ascribing a value to an AI asset; for example, the size of an industry, the number of companies and their revenue and profitability may also be important factors. Similarly, demand in a given area or industry or its future growth and growth potential may also be taken into account.

It is an objective of the present method and a system of grading AI assets to support and facilitate trade and enable AI asset transactions that are suitable to a varied set of AI items so that different entities may be enabled to synthesize solutions from a wide set of AI sources that are chained together for performing complex computing tasks and are sourced from the AI Asset Exchange.

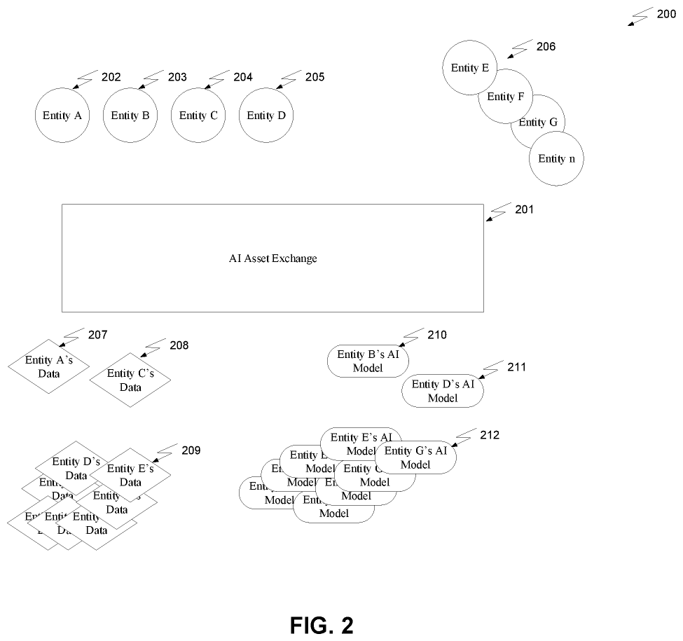

FIG. 2 shows one embodiment of the invention 200, including a logical view of the AI Asset Exchange 201 and the different entities and the AI assets they may own or have rights to transact.

Entity A 202 owns or has rights to Entity A's Data 207. Entity B 203 owns or has rights to Entity B's AI Model 210. Entity C 204 owns or has rights to Entity C's Data 208. Entity D 205 owns or has rights to Entity D's AI Model 211.

Similarly, other entities 206 (Entity E, Entity F, Entity G to Entity n) have rights to transact Data sets 209 and AI Models 212.

AI Models may include but are not limited to Decision Trees, Linear Regression Models, Support Vector Machines, Artificial Neural Networks and the like. Artificial Neural Systems is an approach to AI where the system aims to model the human brain, simple processes are interconnected in a way that they simulate the connection of the nerve cells in the human brain, and the output from the ANS is compared with the expected output and the processors can be retrained.

AI assets may include reasoning related items e.g. non-monotonic reasoning, model-based reasoning, constraint satisfaction, qualitative reasoning, uncertain reasoning, temporal reasoning, heuristic searching etc.

AI assets may include Machine Learning related e.g. evolutionary computation, case-based reasoning, reinforcement learning, neural network, data analysis etc.

AI assets may include Knowledge Management related items e.g. logic, multiagent systems, decision support system, knowledge management, knowledge representation, ontology and semantic web, computer-human interaction etc.

AI assets may include items related to robotics, perception, and natural language processing related; robotics and control, artificial vision including sensing and recognizing images, speech recognition, speech synthesis etc.

Natural Language Processing and Speech Recognition include AI systems that can be controlled and respond to human verbal commands, including classification, machine translation, question answering, text and speech generation, speech including speech-to-text, text-to-speech, speech synthesis etc.

Vision systems may include computing that may be used to sense, recognize and make sense of images, comparisons to Knowledge Base, pattern matching and understanding objects, including systems for image recognition, machine vision and the like.

Machine Learning (ML) may include deep learning, supervised and unsupervised learning, robotics, expert systems, and planning.

Natural Language Understanding (NLU) may include subtopic in Natural Language Processing (NLP) which focus on how to best handle unstructured inputs such as text (spoken or typed) and convert them into a structured form that a machine can understand and act upon. The result of NLU is a probabilistic understanding of one or more intents conveyed, given a phrase or sentence. Based on this understanding, an AI system may then determine an appropriate disposition.

Natural Language Generation on the other hand, is the NLP task of synthesizing text-based content that can be easily understood by humans, given an input set of data points. The goal of NLG systems is to figure out how to best communicate what a system knows. In other words, it is the reverse process of NLU.

Generative Neural Nets or Generative Adversarial Networks (GAN) is an unsupervised learning technique where given samples of data (e.g. images, sentences) an AI system can then generate data that is similar in nature. The generated data should not be discernable as having been artificially synthesized.

The AI assets may be anonymized before being offered for trade. Techniques such as homomorphic encryption may be advantageously used and the AI assets may be made available preferably in an encrypted form for trading.

Homomorphic encryption is a method of performing calculations on encrypted information without decrypting it first. Homomorphic encryption allows computation on encrypted data and may produce results that are also encrypted.

Homomorphic encryption can also be used to securely chain together different services without exposing sensitive data or the AI model to any of the participants in the chain. For example, Entity A's model can be used to produce a result after interacting with Entity B's encrypted data set. In this case homomorphic encryption prevents Entity A from knowing what Entity B's data is and also prevents Entity B from knowing anything about Entity A's AI model.

Thus, homomorphic encryption enables entities to chain together in providing a final solution without exposing the unencrypted data or the AI model to each of those entities participating in the chaining process.

The present system and method aims to enable the smooth handover of the AI assets being transacted between two or more entities so that the buyers and sellers are anonymized. In one embodiment of the invention the anonymization of the AI Assets may be at the AI asset exchange level. While in another embodiment of the invention this process may be at the level of the buyers and sellers, thus the system and method of invention ensures that all entities are anonymized and none of the participants in a transaction know who the others entities are.

In one embodiment a financial transaction is completed as an agreement, or at least a communication is carried out between a buyer and a seller with a view to exchanging an AI asset for a payment. The AI Asset Exchange may deduct a fee for enabling such a transaction. Non-monetary and in-kind (or exchange of services) transactions may also be supported.

A financial transaction involves a change in the status of the finances of two or more entities involved in the transaction. Preferably the buyer and seller are separate entities where a seller is an entity that is seeking to part with certain goods, while a buyer is an entity seeking to acquire the said goods being sold by the seller in exchange for an instrument of conveying a payment e.g. money.

In one embodiment an AI asset is exchanged for an instrument of payment e.g. money; and results in a decrease in the finances of the purchaser and an increase in the finances of the sellers while the AI Asset Exchange may preferably deduct a fee for enabling the said financial transaction.

In one embodiment the financial transaction may be such that the AI asset and money are exchanged at the same time, simultaneously. In another embodiment a financial transaction may be such that the AI asset is exchanged at one time, and the money at another for example in one case the money is paid in advance, while in another case the money is paid after the AI asset has been utilized e.g. payment is made after having trained an AI model for a period of ten days on a given set of data.

In one embodiment complete financial transaction between the buyer of the AI asset and the seller of the AI asset by decreasing the finances of the purchaser and increasing the finances of the sellers and preferably the AI Asset Exchange deducts a fee from the amount paid by the seller for enabling the financial transaction.

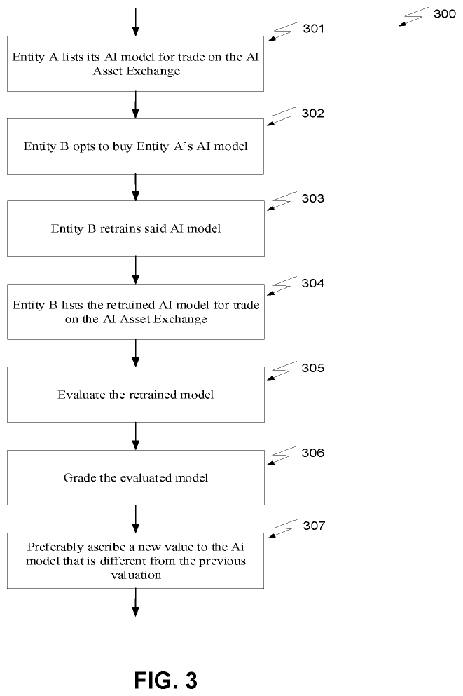

FIG. 3 shows one embodiment 300. Entity A lists its AI model for trade on the AI Asset Exchange 301.

Entity B opts to buy Entity A's AI model 302. In other embodiments or scenarios an Entity may opt to rent, lease, borrow, exchange etc., the AI asset.

The present system and methods aim to enable the rights management of AI assets to control and enforce the AI Asset transactions. For example, if a dataset or a model was rented or leased for a duration of 5 days, then automatically expiring the encryption keys after that duration to enforce the agreement. This enables transactions like renting data for a duration, buying a portion of a data set, buying a given number of hops of data training from different entities for model training, each hop may have a notion of limited time (renting for a duration) and data size (train on a part of data set or whole data set) associated with it.

Entity B retrains the AI model 303. Model training and retraining may include but is not limited to Example Collection, Example Generation, Example Curation, Training/Validation/Test Sets, Loss/Error and Update Model etc.

The Training Modes may include but are not limited to Supervised and Unsupervised learning, Reinforcement learning, Online learning i.e. learn as you go amongst others by using online assets.

Entity B lists the retrained AI model for trade on the AI Asset Exchange 304.

The retrained model is evaluated 305. The new evaluation process may use techniques and methods used earlier for the given AI Asset or may use entirely different techniques and methods, as the criteria for the AI Asset may change entirely after the retraining process and may require different techniques and methods and different sequences for them.

The evaluated model is then graded 306. The grading may preferably use methods and techniques described above. The baseline created earlier for the said AI model may be used for the (re)grading process. It is not necessary that the training process may improve an AI model, as it is entirely possible to actually degrade it in this process.

In one embodiment an AI model may be evaluated and graded based on its accuracy against a test data set. While in another embodiment of the invention the AI model may be graded based on its accuracy against a predefined data set or well-known industry datasets such as MNIST.

If the AI model has a better evaluation than the previous baseline or performs better in the evaluation process against different sets of data that were not deemed suitable in the first evaluation, then the system should grade it higher than before.

If the AI model has a lower or worse evaluation than the previous baseline or performs inferiorly in the evaluation process against the same sets of data used earlier or different sets of data that were not deemed suitable in the first evaluation, then grade it lower than before.

Preferably, a new value is ascribed to the AI model that is different from the previous valuation 307.

The new value ascribed to an AI model after it has been retrained and re-evaluated may be higher than before, may be lower than before or may stay the same as before if no appreciable changes, improvements or degradations are found.

The new value may also be impacted if the relevance, applicability and ranking vis-a-vis different industries changes with the retraining. If initially a model or dataset was relevant and applicable to a given industry, and the retraining made it more relevant and applicable to a different industry or changed its raking for an in-demand niche then its new ascribed value may be higher than before.

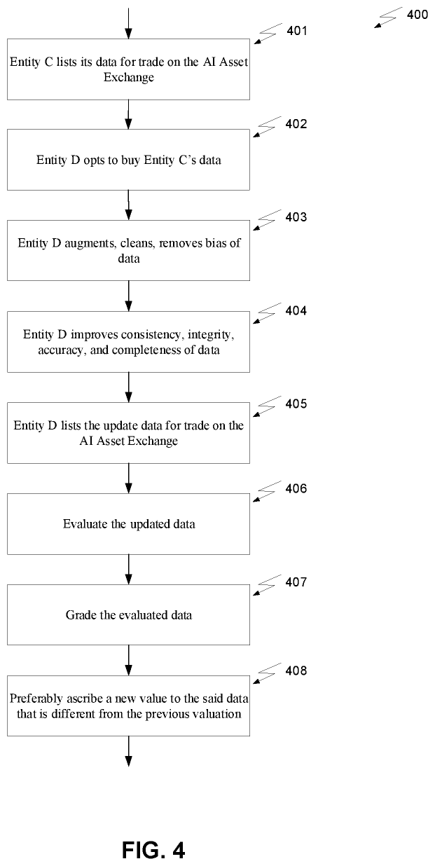

FIG. 4 shows one embodiment 400. Entity C lists its data for trade on the AI Asset Exchange 401.

Entity D opts to buy Entity C's data 402.

Entity D augments, cleans, removes bias of data 403.

Entity D improves consistency, integrity, accuracy, and completeness of data 404.

Entity D lists the updated data for trade on the AI Asset Exchange 405.

The updated data is evaluated 406, preferably using models, methods and techniques described earlier. The baseline created earlier for the AI data may be used for the (re)evaluation process. It is not necessary that the training process may improve an AI data set, as it is entirely possible to actually degrade it in this process.

The evaluated data is graded 407. If the AI data evaluation shows improvements from the previous baseline or performs better in the evaluation process against different models that were not deemed suitable in the first evaluation, then grade it higher than before.

If the AI data has a lower or worse evaluation than the previous baseline or performs inferiorly in the evaluation process against the same models used earlier or different AI models that were not deemed suitable in the first evaluation, then grade it lower than before.

Preferably a new value is ascribed to the data that is different from the previous valuation 408.

The new value ascribed to an AI data as it is modified may be higher than before, may be lower than before or may stay the same as before if no appreciable changes, improvements or degradations are found.

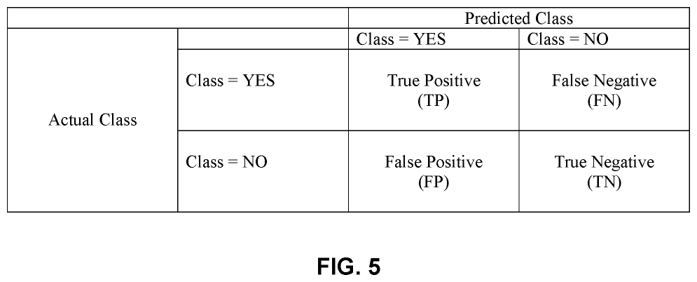

A confusion matrix is a table that is used to describe the performance of a classification model on a set of test data for which the true values are known. FIG. 5 shows an exemplary confusion matrix.

True Positives (TP)—These are the correctly predicted positive values which means that the value of actual class is YES and the value of predicted class is also YES.

True Negatives (TN)—These are the correctly predicted negative values which means that the value of actual class is NO and value of predicted class is also NO.

False Positives (FP)—When actual class is NO and predicted class is YES.

False Negatives (FN)—When actual class is YES but predicted class in NO

True positive and true negatives are therefore observations that are correctly predicted and the goal is to minimize false positives and false negatives.

Accuracy—Accuracy is the most intuitive performance measure and it is the ratio of correctly predicted observation to the total observations therefore:

Accuracy=(TP+TN)/(TP+TN+FP+FN)

Precision—Precision is the ratio of correctly predicted positive observations to the total predicted positive observations therefore

Precision=TP/(TP+FP)

Recall (Sensitivity)—Recall is the ratio of correctly predicted positive observations to the all observations in actual class—YES therefore:

Recall=TP/(TP+FN)

F1 Score—F1 Score is the weighted average of Precision and Recall; therefore

F1 Score=2*(Recall*Precision)/(Recall+Precision)

In one embodiment Precision, Recall, and F-measure (F1 Score) may advantageously used for evaluating an AI model. Recall measures the extent to which all the tuples were produced, while precision measures the extent to which only correct tuples are included in the output, and F1 Score combines recall and precision into a single score to determine the merit of the AI model.

In one embodiment a Receiver Operating Characteristics (ROC) curve and its Area Under the Curve (AUC) and other parameters which are called Confusion Metrics may also be used for evaluating an AI model.

Intrinsic and extrinsic evaluations form another contrast that is often invoked in discussions of evaluation methodologies. In an intrinsic evaluation, system output is directly evaluated in terms of a set of norms or predefined criteria about the desired functionality of the system itself. In an extrinsic evaluation, system output is assessed in its impact on a task external to the system itself.

In one embodiment formative evaluation, which is lightweight and iterative, and summative evaluation, which is through and system wide, may be used for evaluating an AI model.

Each component may be evaluated individually, or multiple components may be evaluated at one instance while also evaluating the entire set of components as a whole to evaluate the AI model.

The program code may execute entirely on a computing device like a server, a cluster of servers, computing devices that are physical or virtual, or a server farm; partly on a physical server and partly on a virtual server. The different computing devices may be connected to each other through any type of network, including a local area network (LAN) or a wide area network (WAN), or the connection may be made to the internet through a mobile operator network (e.g. a cellular network).

Several exemplary embodiments/implementations of the invention have been included in this disclosure. There may be other methods obvious to the ones skilled in the art, and the intent is to cover all such scenarios. The application is not limited to the cited examples, but the intent is to cover all such areas that may be benefit from this invention. The above examples are not intended to be limiting but are illustrative and exemplary.

What is claimed is:

1. A method for grading an artificial intelligence (AI) asset, comprising the steps of:
receiving an AI asset for transaction;
evaluating performance of the AI asset on a specialized task and establishing a baseline of performance based on an evaluated state of the AI asset;
grading the AI asset based on the evaluated performance in a task-environment; and
ascribing a value to the AI asset; and
making the AI asset available for transaction on an AI asset exchange.

2. The method of claim 1, wherein the AI asset is an AI model and the evaluation step comprises evaluation on a set of test data for which true values are known.

3. The method of claim 2, wherein the test data is an MNIST data set.

4. The method of claim 2, wherein the baseline is a baseline measurement of accuracy.

5. The method of claim 2, wherein the baseline is a baseline measurement of precision.

6. The method of claim 2, wherein the baseline is a baseline measurement of recall.

7. The method of claim 2, wherein the baseline is a weighted average of precision and recall.

8. The method of claim 1, wherein the evaluation is an intrinsic evaluation.

9. The method of claim 1, wherein the evaluation is an extrinsic evaluation.

10. The method of claim 1, wherein the evaluation is a formative evaluation.

11. The method of claim 1, wherein the evaluation is a summative evaluation.

12. The method of claim 1, wherein the AI asset is a classification model and the evaluation step includes evaluation in a confusion matrix.

13. The method of claim 1, wherein the evaluation is for reliability in a core area of expertise.

14. The method of claim 1, wherein the evaluation is for predictability.

15. The method of claim 1, wherein the evaluation is for learning/adaptation ability.

16. The method of claim 1, wherein the evaluation is for adaptivity.

17. The method of claim 1, wherein the evaluation is for ability to recursively self-improve.

18. The method of claim 1, wherein the evaluation is for resource or time requirements.

19. The method of claim 1, wherein the AI asset is a chatbot or dialogue model and the evaluation incorporates a recurrent neural network (RNN) architecture.

20. A method for grading an artificial intelligence (AI) asset, comprising the steps of:
receiving an AI asset for transaction;
performing a first evaluation of performance of the AI asset on a specialized task and establishing a baseline of performance based on an evaluated state of the AI asset;
performing a first grading of the AI asset based on the evaluated performance in a task-environment; and
ascribing a first valuation to the AI asset;
following a transaction to a party of the AI asset for training the AI asset, receiving the AI asset back from the party;
performing a second evaluation of performance of the AI asset on the same specialized task and comparing the performance to the baseline;
performing a second grading of the AI asset based on the comparison to the baseline; and
ascribing a second valuation to the AI asset.

21. The method of claim 20, further comprising making the AI asset available at the second value.
